(19) United States
(12) Patent Application Publication
(10) Pub. No.: US 2015/0135115 A1
(43) Pub. Date: May 14, 2015

(54) MULTI-TOUCH INPUT FOR CHANGING TEXT AND IMAGE ATTRIBUTES

(71) Applicant: Lenovo (Singapore) Pte. Ltd., Singapore (SG)

(72) Inventors: Xin Feng, Arcadia, CA (US); Jeffrey E. Skinner, Raleigh, NC (US); Mei-Wen Sun, Raleigh, NC (US)

(73) Assignee: Lenovo (Singapore) Pte. Ltd., Singapore (SG)

(21) Appl. No.: 14/076,798

(22) Filed: Nov. 11, 2013

(51) Int. Cl. G06F 3/0488; G06F 3/0482; G06F 3/0484; G06F 3/0481

(52) U.S. Cl. CPC G06F 3/04883; G06F 3/04817; G06F 3/0482; G06F 3/04845
USPC 715/771

(57) ABSTRACT

An embodiment provides a method, including: accepting, at a touch input component, touch input; rendering, on a display device, the touch input in a touch input interface; determining, using a processor, multi-touch input for modifying an attribute of the touch input rendering; modifying, using the processor, the attribute of the touch input rendering according to the multi-touch input; and thereafter inputting the touch input rendering into an application. Other aspects are described and claimed.

### BACKGROUND

Information handling devices (“devices”), for example laptop computers, tablets, smart phones, e-readers, etc., may be used to accept user inputs in various formats. Among the formats of user inputs currently utilized are “touch” inputs, although this category of inputs includes inputs where physically touching a surface may not be required. For example, gestures proximate to or detectable by an input component may be registered as inputs.

A user input component accepts the touch inputs. Examples of input components include touch sensitive surfaces, such as a touch screen (for direct input) or a digitizer or touch pad (for indirect or separate input from a display). The touch inputs may be provided using various objects, e.g., a writing implement such as a pen or stylus or even finger input. Commonly touch inputs are used in a drawing or handwriting touch input user interface which allows a user to provide handwriting or drawing inputs to another application, e.g., word processing application, email application, etc.

### BRIEF SUMMARY

In summary, one aspect provides a method, comprising: accepting, at a touch input component, touch input; rendering, on a display device, the touch input in a touch input interface; determining, using a processor, multi-touch input for modifying an attribute of the touch input rendering; modifying, using the processor, the attribute of the touch input rendering according to the multi-touch input; and thereafter inputting the touch input rendering into an application.

Another aspect provides an information handling device, comprising: a touch input component; a display device; a processor; and a memory device storing instructions executable by the processor to: accept, at the touch input component, touch input; render, on the display device, the touch input in a touch input interface; determine multi-touch input for modifying an attribute of the touch input rendering; modify the attribute of the touch input rendering according to the multi-touch input; and thereafter input the touch input rendering into an application.

A further aspect provides a program product, comprising: a storage medium comprising computer readable program code, the computer readable program code comprising: computer readable program code configured to accept, at a touch input component, touch input; computer readable program code configured to render, on a display device, the touch input in a touch input interface; computer readable program code configured to determine, using a processor, multi-touch input for modifying an attribute of the touch input rendering; computer readable program code configured to modify, using the processor, the attribute of the touch input rendering according to the multi-touch input; and computer readable program code configured to thereafter input the touch input rendering into an application.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3(A-C) illustrates examples of using multi-touch input for changing text attributes.

FIG. 4(A-C) illustrates examples of using multi-touch input for changing image attributes.

FIG. 5 illustrates an example method for using multi-touch input for changing text or image attributes.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In a touch user input handwriting or drawing interface, such as a text/image editor, conventionally the user needs to use menu command/icons to setup the attribute(s) of the text or image. For example, to modify a size attribute of the text input or image, the user needs to separately select size setting within the editor. Likewise, to rotate, tilt or flip the text or image, the user needs to select the appropriate modification for a rotation attribute within the editor application/user interface. Thus, a user may either set the attributes prior to entering touch inputs, which are then rendered with the previously set (e.g., default) attributes (size, rotation or orientation, etc.); or, the user may provide the touch input to render the text or image, and thereafter modify attributes, again using menu selections in the editor application.

This modal approach is inconvenient for a variety of reasons. For example, since a user needs to switch back and forth between a command mode (for modifying attributes) and a content mode (for inputting touch input to be rendered), the natural flow of input will be disrupted. Additionally, for user interfaces or editors with limited space, e.g., as provided on a smart phone or other space limited form factors, it is challenging to accommodate additional icons/menu commands within the interface for making such modifications. Additionally, while a user may modify/edit (i.e., change an attribute such as size or rotation) an image after it is completed (e.g., re-sizing an image file), the user needs to do this once the image is complete and cannot add to the image thereafter by drawing further inputs. Conventionally there is no way at all to modify handwriting text/character input, leaving the user with limited options.

Accordingly, an embodiment provides a user with an opportunity to easily modify attributes of text and/or image input while using a touch input interface/editor. An embodiment may distinguish between touch input for providing substantive input, i.e., for creating a rendering, and touch input for modifying attributes of the touch input rendering. In an embodiment, a multi-touch input is mapped to a predetermined modification such that, on receipt of such a multi-touch input, the touch input rendering may be modified without the user needing to switch between modes. Thus, users may seamlessly modify attributes (e.g., size, rotation) of touch input renderings without needing to switch between modes using buttons or menu choices within the interface to do so. Additionally, an embodiment permits a user to modify attributes while providing touch input renderings, i.e., prior to completing the touch input for entry into an application.

The illustrated example embodiments will be best understood by reference to the figures. The following description is intended only by way of example, and simply illustrates certain example embodiments.

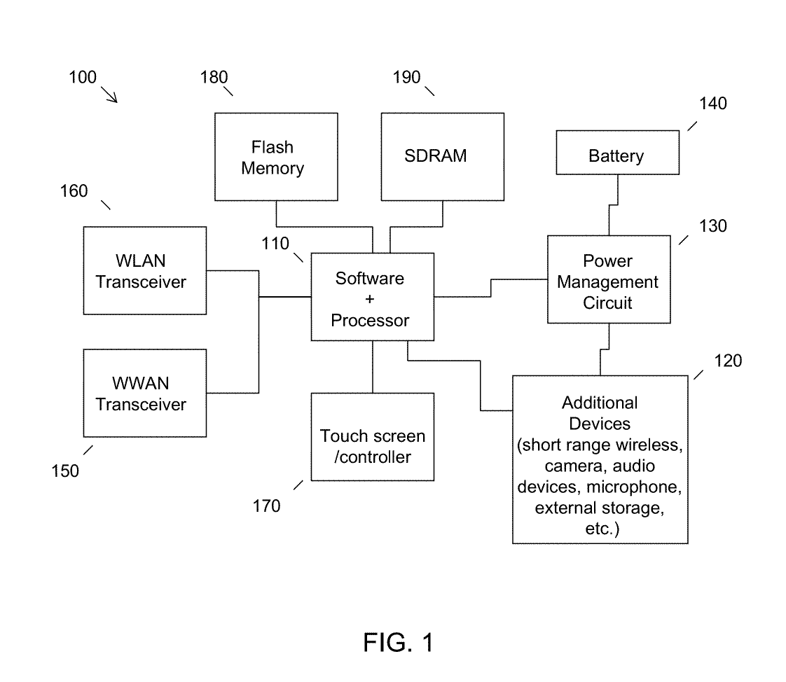

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a short range wireless communication device, such as a BLUETOOTH radio. Commonly, system 100 will include a touch screen 170 for data input and display, e.g., for accepting touch inputs. System 100 also typically includes various memory devices, for example flash memory 180 and SDRAM 190.

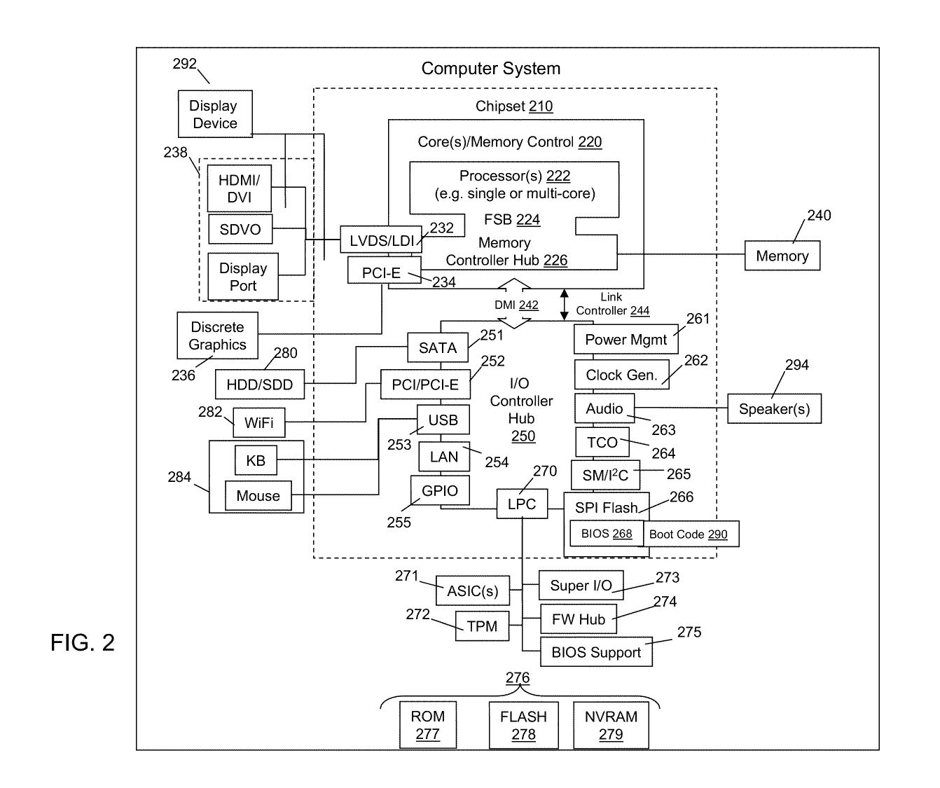

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, et cetera), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used for accepting and rendering touch inputs, for example handwriting inputs or image inputs (collectively referred to herein as drawing inputs). For example, on a touch input component such as a touch screen, touch pad, digitizer, etc., a user may provide drawing inputs, such as handwritten text and/or drawing in the form of images. These touch inputs are rendered in a display device. The touch inputs may thereafter be input into an application, e.g., converting handwriting inputs into text, importing the image input into an email application, etc.

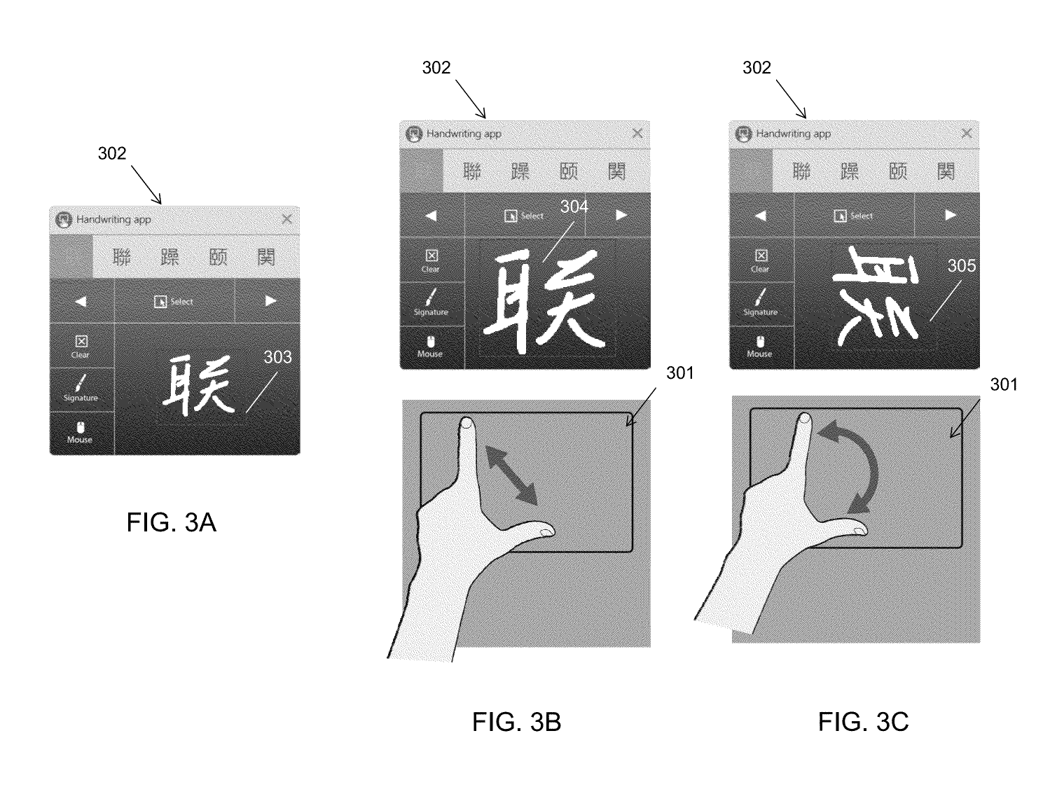

As illustrated in FIG. 3(A-C), a touch input component 301, e.g., a touch sensitive surface such as a touch pad or touch screen, may be used to render touch inputs in a touch input interface or editor 302. In the touch input interface 302 the touch inputs are rendered for display, for example touch input rendering 303.

As described herein, in order to modify an attribute, e.g., a size attribute of a touch input rendering, a user normally would have to select a menu choice with the touch input interface 302 to resize the rendering 303. According to an embodiment, however, a user may modify the size of the rendering 303 by providing a multi-touch input to the input component 301.

Therefore, referring to FIG. 3B by way of example, if a user provides a pinch or zoom multi-touch input to a touch input component 301, the rendering 303 may be resized, e.g., enlarged to a modified rendering 304 having an enlarged size attribute according to the multi-touch input provided. As may be appreciated from FIGS. 3A and 3B, the user need not select an editing function from within the touch input interface 302. Rather, an embodiment automatically interprets the multi-touch input provided to the surface 301 as an attribute modification input, and distinguishes this from a typical, single touch input to the surface 301, i.e., one that may be used for forming the character of text input.

Likewise, referring to FIG. 3C, an embodiment may map another multi-touch input to the touch input component 301 as attribute modification input to rotate the text rendering to the version 305. In this example, the user has provided a multi-touch input in the form of using two fingers to rotate the text rendering to the orientation of 305, i.e., rotated 90 degrees from version 303. Again, the user need not select a rotation menu choice. Rather, an embodiment automatically maps the multi-touch rotation input provided to the touch input component 301 as an attribute modification input to rotate the input rendering.

As will be appreciated form FIG. 3(A-C), the touch input interface 302 may provide options for entering a touch input rendering 303, in this example a handwritten character of a character based language (which may equally be an alphanumeric character, symbol, or the like). For example, the handwriting input may be analyzed to determine a machine text character to which it corresponds. In this example, a listing of five potential characters is provided in an upper preview panel of the input interface 302. Thus, a user may have the handwriting input 303 provided to or input to another application, e.g., a word processing or email application, etc., in the form of machine text, e.g., selected from the preview panel.

In an embodiment, the modified attribute of the touch input rendering, e.g., modified size or rotation of renderings 304 and 305, respectively, may be retained on converting the touch input rendering into machine text. As an example, a user may provide a multi-touch rotation input to rotate a rendered text character, e.g., similar to 305, to italicize or rotate it slightly (e.g., less than the 90 degree rotation illustrated for rendering 305). Accordingly, the machine input text may be in the form of an italicized character input into the underlying application (e.g., email application).

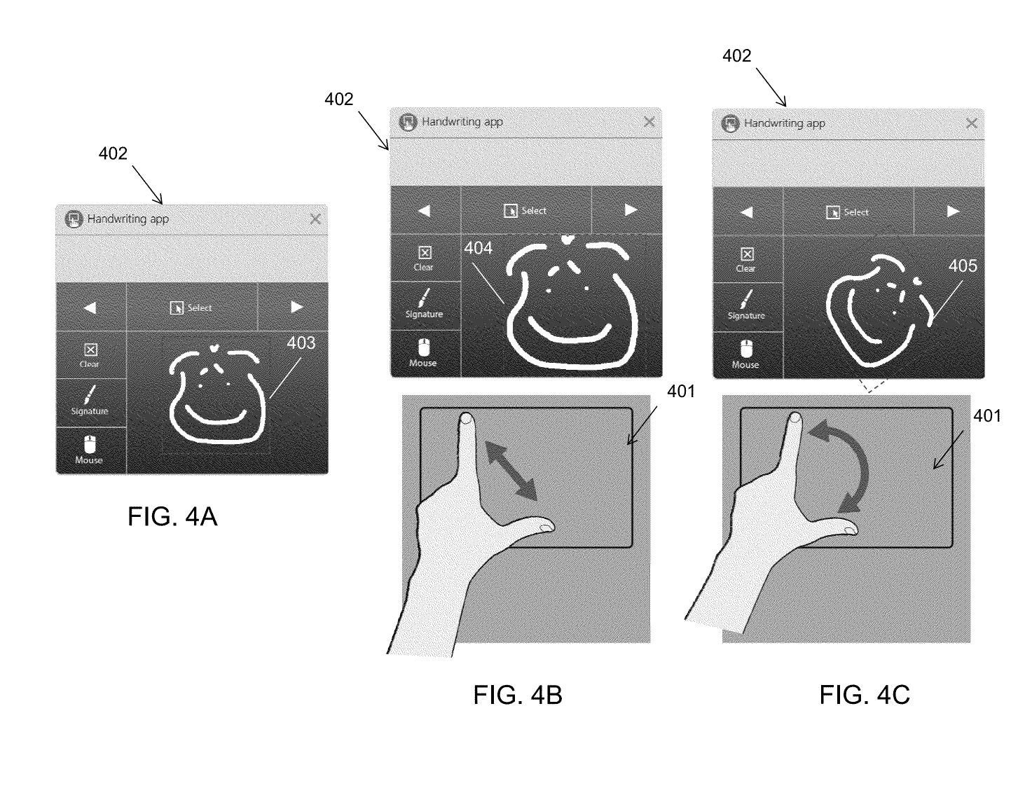

The touch input rendering need not be converted, e.g., to machine text. Thus, the handwriting input may be directly imported to another application, e.g., retaining the modified attributed. To illustrate this, a drawing or image input is illustrated in FIG. 4(A-C).

As shown, a user may provide touch input to a surface 401 for rendering in a touch input interface 402. Similar to the text character input 303, an image 403 is rendered in the touch input interface 402. In a similar way, an embodiment may allow a user to provide a multi-touch input to the input component 401, as for example a pinch or zoom multi-touch input as illustrated in FIG. 4B, to modify an attribute of the image. Again, the may be accomplished without requiring the user to explicitly switch modes. Thus, as shown in FIG. 4B, the image attribute of size is changed to enlarge the image rendering 404. Like in FIG. 3C, the user may provide other multi-touch inputs to modify other attributes. Thus, as shown in FIG. 4C, the user may provide a multi-touch rotation input that is mapped to automatically rotate the image rendering to the form of 405. Thus, a user may provide multi-touch inputs for modifying attributes of touch inputs seamlessly or in line, i.e., without needing to switch between modes.

When the user is satisfied both with the touch inputs themselves and the attributes (e.g., size, rotation, etc.) the user may commit the inputs to an application, e.g., email, word processing or like applications.

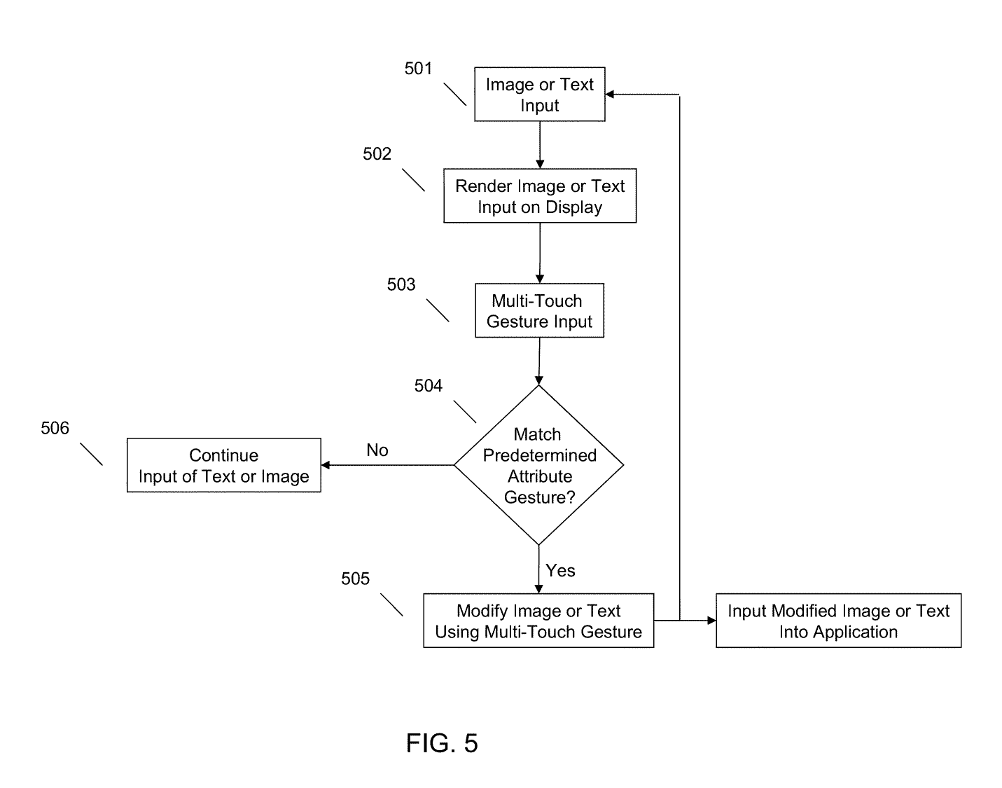

For example, referring to FIG. 5, a user may provide image or text inputs to an input component at 501. The touch inputs will be rendered in a touch input interface at 502. While providing such touch inputs, a user may determine that a modification to an attribute such as size, rotation or the like is desirable. Accordingly, a user may provide a multi-touch gesture, such as a pinch with two fingers or a rotation with two fingers, at 503.

As described herein, an embodiment will automatically interpret such multi-touch gestures as attribute modifying input, e.g., as mapped to a predetermined number of multi-touch gestures for modifying attributes, at 504. If such a predetermined multi-touch input has been received, as determined at 504, an embodiment may modify the attribute(s) according to the received multi-touch inputs at 505. Otherwise, an embodiment may not modify the attributes and permit the user continue providing touch input for rendering. Notably, an embodiment permits the user to modify an attribute using a multi-touch gesture, and thereafter seamlessly return to providing additional touch inputs, e.g., to continue drawing or providing handwriting inputs. For example, an embodiment detects that the multi-touch gesture has finished and that a single touch or single point gesture is thereafter provided. The single touch or single point gestures will thereafter be rendered, similar to the inputs provided at 501.

Once the user has finished providing touch inputs for rendering and providing multi-touch inputs for modifying attribute(s) of the touch input renderings, an embodiment may provide the finished input renderings to an underlying application. As described herein, this may include additional steps, e.g., converting the modified touch input renderings into associated machine text, symbols, drawings or the like.

As described herein, an embodiment provides a user with an opportunity to easily modify attributes of text and/or image input while using a touch input interface/editor. An embodiment provides seamless transitioning between providing touch input for rendering and providing multi-touch input for modifying attributes of the rendering, and automatically switching there-between. Thus, users may seamlessly modify attributes (e.g., size, rotation) of touch input renderings without needing to switch between modes using buttons or menu choices within the interface to do so. Additionally, this reduces the amount of necessary menu options that need to be provided within the touch input interface, which often are provided in small devices where space is at a premium.

As will be understood by one skilled in the art, various aspects may be embodied as a system, method or device program product. Accordingly, aspects may take the form of an entirely hardware embodiment or an embodiment including software that may all generally be referred to herein as a “circuit,” “module” or “system.”Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
accepting, at a touch input component, touch input;
rendering, on a display device, the touch input in a touch input interface;
determining, using a processor, multi-touch input for modifying an attribute of the touch input rendering;
modifying, using the processor, the attribute of the touch input rendering according to the multi-touch input; and
thereafter inputting the touch input rendering into an application.

2. The method of claim 1, wherein the multi-touch input comprises a pinch input to change a size attribute of the touch input rendering.

3. The method of claim 1, wherein the multi-touch input comprises a rotation input to change a rotation attribute of the touch input rendering.

4. The method of claim 1, wherein the touch input comprises drawing input.

5. The method of claim 4, wherein the drawing input comprises handwriting input including a character.

6. The method of claim 5, further comprising converting the handwriting input to machine text for inputting into the application.

7. The method of claim 6, wherein a modified attribute of the handwriting input is retained by the machine text.

8. The method of claim 4, wherein the drawing input comprises image input.

9. The method of claim 8, wherein the image input is not converted to machine text for inputting to the application.

10. The method of claim 1, wherein the touch input component comprises a touch sensitive surface located in a different area of a device than the display device.

11. An information handling device, comprising:
a touch input component;
a display device;
a processor; and
a memory device storing instructions executable by the processor to:
accept, at the touch input component, touch input;
render, on the display device, the touch input in a touch input interface;
determine multi-touch input for modifying an attribute of the touch input rendering;
modify the attribute of the touch input rendering according to the multi-touch input; and
thereafter input the touch input rendering into an application.

12. The information handling device of claim 11, wherein the multi-touch input comprises a pinch input to change a size attribute of the touch input rendering.

13. The information handling device of claim 11, wherein the multi-touch input comprises a rotation input to change a rotation attribute of the touch input rendering.

14. The information handling device of claim 11, wherein the touch input comprises drawing input.

15. The information handling device of claim 14, wherein the drawing input comprises handwriting input including a character.

16. The information handling device of claim 15, wherein instructions are further executable by the processor to convert the handwriting input to machine text for inputting into the application.

17. The information handling device of claim 16, wherein a modified attribute of the handwriting input is retained by the machine text.

18. The information handling device of claim 14, wherein the drawing input comprises image input.

19. The method of claim 8, wherein the image input is not converted to machine text for inputting to the application.

20. A program product, comprising:
a storage medium comprising computer readable program code, the computer readable program code comprising:
computer readable program code configured to accept, at a touch input component, touch input;
computer readable program code configured to render, on a display device, the touch input in a touch input interface;
computer readable program code configured to determine, using a processor, multi-touch input for modifying an attribute of the touch input rendering;
computer readable program code configured to modify, using the processor, the attribute of the touch input rendering according to the multi-touch input; and
computer readable program code configured to thereafter input the touch input rendering into an application.
